(19) United States
(12) Patent Application Publication
(10) Pub. No.: US 2006/0192865 A1
(43) Pub. Date: Aug. 31, 2006

(54) Noise processing apparatus and image pickup apparatus

(76) Inventor: Kazuhiro Suzuki, Anpachi-Gun (JP)

Correspondence Address: MCDERMOTT WILL & EMERY LLP, 600 13TH STREET, N.W., WASHINGTON, DC, 20005-3096, US

(21) Appl. No.: 11/346,583

(22) Filed: Feb. 3, 2006

(30) Foreign Application Priority Data
Feb. 4, 2005 (JP) 2005-028590
Jan. 25, 2006 (JP) 2006-016364

(51) Int. Cl. H04N 5/217

(52) U.S. Cl. 348/241

(57) ABSTRACT

An image pickup apparatus includes an image pickup unit which picks up an image of an object so as to generate image data, a noise processing unit which processes dark current noise contained in the image data, and an image processing unit which generates images, based on the image data that have undergone the noise processing. The noise processing unit includes a whitening-out determining unit, a memory, a low-frequency component extracting unit and a subtractor. The memory records data values of dark current noise, and the low-frequency component extracting unit extracts low-frequency components from the data value of dark current noise. The whitening-out determining unit determines whether or not any whitening-out is caused in each pixel, and the subtractor subtracts the low-frequency component for the data value of the pixel having a whitening-out and subtracts the data value of dark current noise for the data values of the other pixels.

### BACKGROUND OF THE INVENTION

1. Field of the Invention

The present invention relates to the noise processing technologies, and it particularly relates to a noise processing technology that processes the dark current noise contained in the output signals from an image pickup device.

2. Description of the Related Art

Image pickup devices, such as CCDs (charge coupled devices), are commonly used in image pickup apparatuses, such as digital cameras. And it is known that these image pickup devices produce dark current noise when no light enters their light-receiving surface, that is, with the incident light being blocked. In a known method to eliminate this dark current noise, the data values of dark current noise for an image pickup device are recorded beforehand and the data values of the dark current noise is subtracted from the data values of pixels that have picked up the image of an object.

With an image pickup apparatus using a CCD or like image pickup device, the dynamic range of the image pickup device is generally narrower than that of photographic film, and the amount of light received from a highly luminous part of an object may go beyond the dynamic range thereof. Eventually the output signals from the image pickup device for such a part can get saturated. In such a case, a phenomenon called “whitening-out” may likely to occur, in which detailed image information in the saturated part may be lost and an evenly distributed white area is produced.

In a part where such whitening-out has occurred, the data values of dark current noise contained in the data values of such pixels will also be lost, so that new noises will be created by the subtraction processing of the data values of dark current noise.

Reference (1) in the Related Art List proposes a method in which pixel area of image data where the whitening-out has occurred is determined and then the subtraction processing of dark current noise is interrupted, or the degree of subtraction is reduced, for the pixel area where the whitening-out has occurred.

Related Art List

(1) Japanese Patent Application Laid-Open No. 2002-320144.

A description will be given below of image data that will be generated when a subtraction processing of dark current noise is interrupted for a pixel area where whitening-out has occurred, according to the method of Reference (1). FIGS. 1A to 1C illustrate noise processing when a subtraction processing is interrupted for the part where the whitening-out has occurred.

FIG. 1A schematically illustrates image data before a subtraction processing. The vertical axis represents the signal level of data values of pixels, and the horizontal axis the pixel position on a CCD. A predetermined level is set, for instance, at a maximum signal level. As illustrated in FIG. 1A, data values at and above the predetermined level are cut off to indicate a state in which whitening-out has occurred.

FIG. 1B illustrates data of dark current noise. FIG. 1C shows a result of noise processing by the technique of Reference (1), that is, image data resulting in a case where no subtraction processing of dark current noise is done in the pixel area where the whitening-out has occurred and subtraction processing thereof is done in the other pixel areas. Since the subtraction processing is interrupted in the pixel area where the whitening-out has occurred, there is no generation of new noises due to subtraction processing there.

However, if the subtraction processing is interrupted in the pixel area where the whitening-out has occurred, there will be greater difference in data values between the pixel area where whitening-out has occurred and the surrounding areas, thus creating a large luminance variation at the boundary therebetween.

### SUMMARY OF THE INVENTION

The present invention has been made in view of the foregoing circumstances and an object thereof is to provide a noise processing technology of dark current noise which ensures a smoother connection of a pixel area where whitening-out has occurred to the surrounding pixel areas than in the case where noise processing for the pixel area where whitening-out has occurred is interrupted.

In order to solve the above problems, there is provided a noise processing apparatus, according to a preferred embodiment of the present invention, which comprises: a decision unit which determines, for a pixel of image data generated by an image pickup unit, if a data value is greater than or equal to or strictly greater than a predetermined level; and a subtractor which subtracts a low-frequency component of dark current noise of the image pickup unit from the data value of a pixel when it is determined by the decision unit, for the pixel, that the data value is greater than or equal to or strictly greater than the predetermined level.

According to this noise processing apparatus, the data value of a pixel generated by the image pickup unit is determined to be greater than or equal to or strictly greater than a predetermined level, a low-frequency component of data current noise is subtracted from the data value of said pixel. As a result, the difference in data value between a part where the data value of a pixel is determined to be greater than or equal to or strictly greater than a predetermined value and its surrounding part can be made smaller, so that the pixels can be relatively smoothly connected.

Another preferred embodiment according to the present invention relates to an image pickup apparatus. This image pickup apparatus comprises: an image pickup unit which picks up an image of an object and generates image data thereof; a decision unit which determines, for a pixel of the image data generated by the image pickup unit, if a data value is greater than or equal to or strictly greater than a predetermined level; a subtractor which subtracts a low-frequency component of dark current noise of the image pickup unit from the data value of a pixel when it is determined by the decision unit, for the pixel, that the data value is greater than or equal to or strictly greater than the predetermined level; and an image processing unit which generates images, based on the data value of the pixel on which a subtraction processing is performed by the subtractor.

According to this image pickup apparatus, when the data value of a pixel generated by the image pickup unit is determined to be greater than or equal to or strictly greater than a predetermined level, a low-frequency component of data current noise is subtracted from the data valve of said pixel, a low-frequency component of dark current noise is subtracted from the data value of said pixel. Hence, the difference in data value between a part where the data value of a pixel is determined to be greater than or equal to or strictly greater than a predetermined value and its surrounding part can be made smaller, so that the pixels can be relatively smoothly connected.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIGS. 1A to 1C illustrate a case when a subtraction processing is stopped for part where whitening-out occurs.

FIG. 2 illustrates a structure of an image pickup apparatus according to an embodiment of the present invention.

FIG. 3 illustrates a method for extracting a low-frequency component from a data value of a pixel.

FIG. 4 is a flowchart for acquiring data values of dark current noise according to an embodiment of the present invention.

FIG. 5 is a flowchart of noise processing according to an embodiment of the present invention.

FIGS. 6A and 6B illustrate noise processing according to an embodiment of the present invention.

FIG. 7 illustrates a structure of modification to an image pickup unit according to an embodiment of the present invention.

FIG. 8 is a flowchart for acquiring image data according to a modification of an embodiment of the present invention

FIG. 9 is a flowchart of noise processing according to a modification of an embodiment of the present invention.

### DETAILED DESCRIPTION OF THE INVENTION

The description will now be given, in detail, of embodiments according to the present invention by referring to figures.

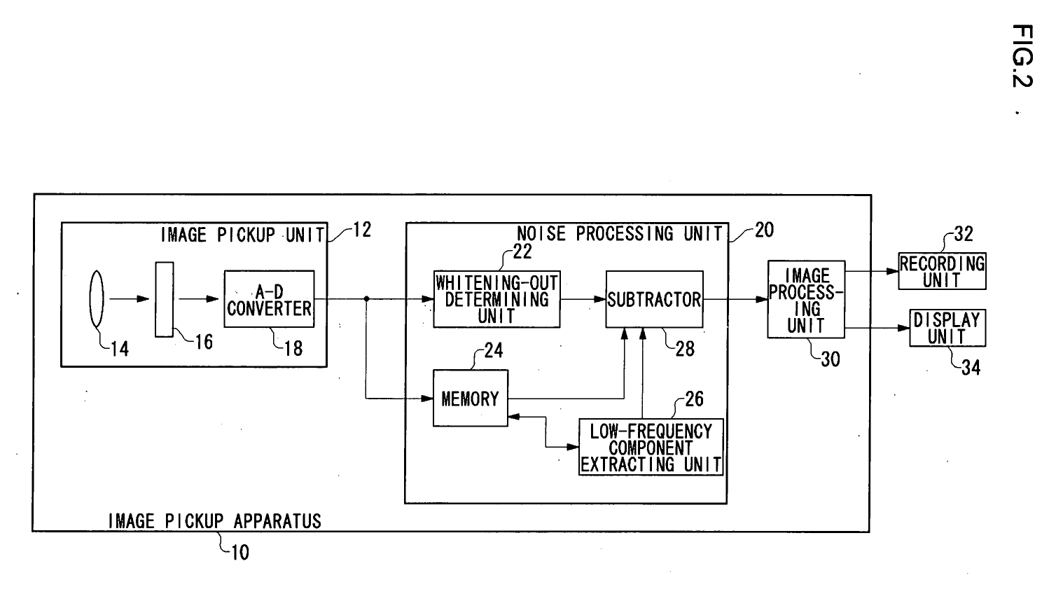

FIG. 2 is a block diagram showing a structure of an image pickup apparatus according to an embodiment of the present invention. An image pickup apparatus 10 is comprised of an image pickup unit 12 which captures an image of an object and generates image data, a noise processing unit 20 which processes dark current noise contained in the image data, and an image processing unit 30 which generates images based on the image data that have undergone the noise processing.

The image pickup 12 unit includes lens 14, an image pickup device 16 and an A-D converter 18. The light is converted into electric signals by the image pickup device 16 via the lens 14. The electric signals are analog values, and they may be subjected to some sort of analog signal processing before they are inputted to the A-D converter 18. The image pickup device 16 may be a CCD or CMOS. The image data which have been converted to electric signals are converted into digital values by the A-D converter 18 and supplied to a whitening-out determining unit 22 in the noise processing unit 20.

The noise processing unit 20 has a function of removing dark current noise from the image data. The noise processing unit 20 includes a whitening-out determining unit 22, a memory 24, a low-frequency component extracting unit 26 and a subtractor 28.

The noise processing unit 20 according to the present embodiment is realized by a CPU, a memory and a memory-loaded program or the like, but drawn herein are function blocks that are realized in cooperation with those. The program may be built into the image pickup apparatus 10, or may be supplied externally in such a form as to be stored in a recording medium. Thus, it is understood by those skilled in the art that these function blocks can be realized in a variety of forms such as by hardware only, software only or the combination thereof.

The memory 24 has a function of recording data values of dark current noise. Since the dark current noise is liable to be affected by the surrounding temperature environment, recording thereof right before an image pickup assures the acquisition of the data values of dark current noise with the greatest accuracy. The data values of dark current noise may be obtained at power activation of an image pickup apparatus 10. Or they may be obtained at the time of manufacture of an image pickup apparatus 10.

The acquisition of data values of dark current noise is accomplished by obtaining image data with the incident light to the image pickup device 16 being blocked. The data values of dark current noise of the image pickup device 16 are converted into the digital values by the A-D converter 18, which are then recorded in the memory 24.

As described above, after the data values of dark current noise are acquired beforehand, the image pickup unit 12 picks up the image of an object and generates the image data thereof.

The whitening-out determining unit 22 determines whether or not any whitening-out has occurred in the image data having been generated by the image pickup unit 12. Hereinafter, this process will be referred to as “whitening-out determination”. A whitening-out determination is carried out by determining if the data value of a pixel is at a predetermined level or higher or if it is higher than a predetermined level. A whitening-out determination may also be carried out by determining if there are a plurality of consecutive pixels whose values are at a predetermined level or higher, or higher than a predetermined value.

When the whitening-out determining unit 22 carries out a whitening-out determination by seeing if the data value of a pixel is at a predetermined level or higher, the predetermined level is set at the saturation level of the A-D converter 18. For example, where image data is of 8 bits, the predetermined level is the data value of 255.

On the other hand, when the whitening-out determining unit 22 carries out a whitening-out determination by seeing if the data value of a pixel is higher than a predetermined level, the predetermined level is set at a level whose data value is smaller by 1 than the saturation level of the A-D converter 18. For example, where image data is of 8 bits, the predetermined level is the data value of 254. It is to be noted that this predetermined level may be set to an arbitrary value according to the level of dark current noise.

The low-frequency component extracting unit 26 extracts low-frequency components from the data values of dark current noise recorded in the memory 24. For example, when the whitening-out determining unit 22 has determined the presence of whitening-out, the low-frequency component extracting unit 26 extracts low-frequency components from the data values of the dark current noise.

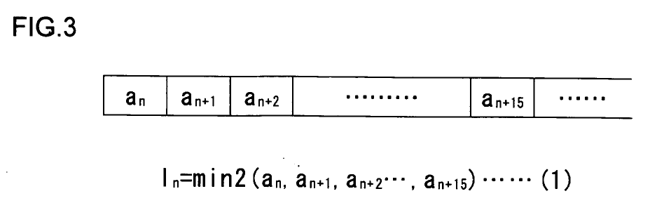

FIG. 3 illustrates an example of method for extracting low-frequency component lₙ from data value aₙ of dark current noise. The low-frequency component lₙ is determined by selecting the second smallest data value from among the data values aₙ and the data values of a plurality of adjacent pixels (aₙ₊₁ to aₙ₊₁₅ in FIG. 3). (See equation (1) in FIG. 3.) Here, “min2( )” represents the second smallest value in parentheses. Note that the second smallest value is used because the smallest data value has a possibility of being a defective pixel or the like and presents low reliability as a normal data value. The data values of low-frequency components thus extracted are sent to the subtractor 28. This low-frequency component extraction processing is carried out for pixels for which the whitening-out determining unit 22 has determined the presence of whitening-out.

For a pixel where it is determined by the whitening-out determining unit 22 that whitening-out is not caused, the subtractor 28 subtracts a data value of dark current noise recorded in the memory 24 from the data value of the pixel. For a pixel where it is determined by the whitening-out determining unit 22 that the whitening-out is caused, the low-frequency component of dark current noise extracted by the low-frequency extracting unit 26 is subtracted from the data value of the pixel.

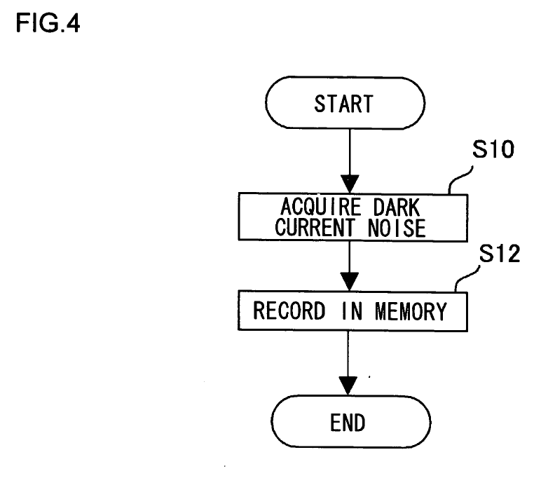

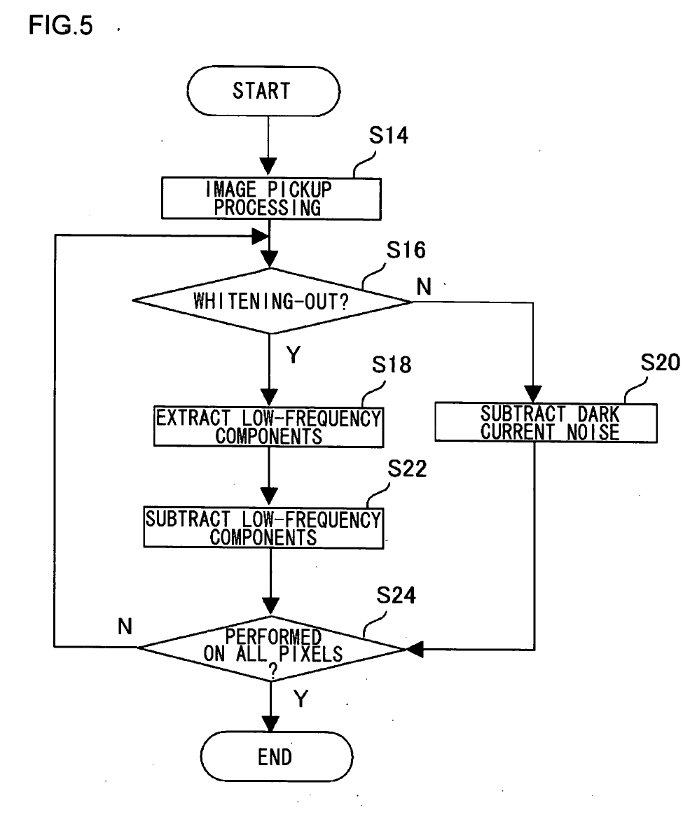

FIG. 4 and FIG. 5 are flowcharts showing noise processings according to an embodiment of the present invention. FIG. 4 is a flowchart for acquiring data values of dark current noise according to an embodiment of the present invention. First, image data are acquired with the incident light to the image pickup device 16 being blocked, so as to acquire a data value of dark current noise (S10). The data values of dark current noise converted to digital values by the A-D converter 18 are recorded in the memory 24 (S12).

FIG. 5 is a flowchart of noise processing according to an embodiment of the present invention. First, image data are acquired by the image pickup unit 12 (S14). The pixel data values of the image data are determined by the whitening-out determining unit 22 in a manner of, for example, whether or not the data value is higher than or equal to a predetermined level pixel by pixel (S16). For the pixel data value whose signal level is higher than or equal to the predetermined level, it is determined that whitening-out is caused (Y of S16), and the low-frequency component is extracted from the data value of said pixel (S18). Then a low-frequency component of dark current noise is subtracted from this pixel data value (S22).

On the other hand, for the pixel data value whose signal level is smaller than the predetermined value, it is determined that whitening-out is not caused (N of S16), and a data value of dark current noise is subtracted (S20).

This processing is repeated until all pixels have undergone the subtraction processing (N of S24). When the subtraction processing has been performed on all pixels and therefore has been completed (Y of S24), the noise processing is completed.

In Step S16, the whitening-out determining unit 22 may perform whitening-out determination by checking whether, for each pixel, the data value is greater than a predetermined level or not. In this case, for the pixel data value whose level is determined to be smaller than or equal to the predetermined level, it is determined that no whitening-out is caused (N of S16) and the data value of dark current noise is subtracted (S20).

The image data where the dark current noise is processed by the noise processing unit 20 are sent to the image processing unit 30, are then subjected to an image processing, such as white balancing, color separation, gamma transformation and compression, and are outputted to a recording unit 32 and a display unit 34.

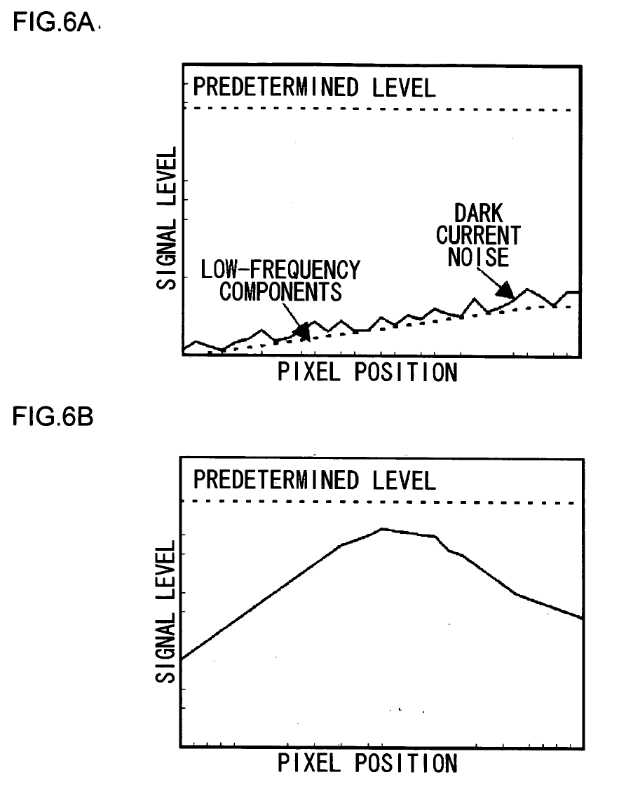

FIGS. 6A and 6B are provided to explain a noise processing according to an embodiment of the present invention. FIG. 6A shows data of dark current noise and low-frequency components extracted from the dark current noise. For a pixel area in which it is determined by the whitening-out determining unit 22 that whitening-out is caused, the subtraction processing is performed only on the low-frequency components of dark current noise shown in FIG. 6A. For a pixel area in which it is determined thereby that no whitening-out occurs, the subtraction processing is performed on data values of dark current noise shown in FIG. 6A.

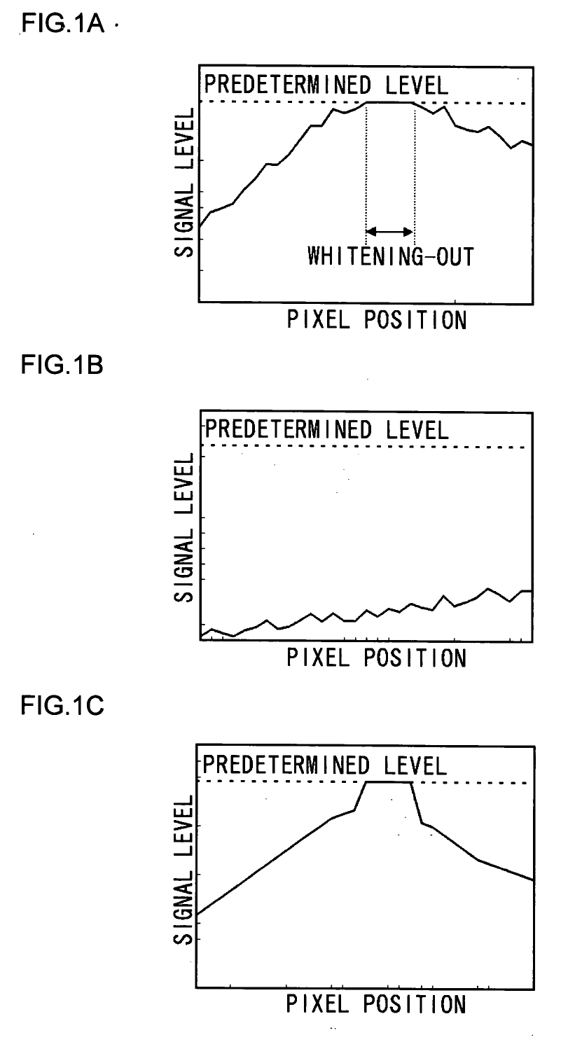

FIG. 6B shows image data that have undergone the noise processing. Image data on which the noise processing is to be performed are the image data shown in FIG. 1A. In comparison with the noise processing as shown in FIG. 1C, according to the present embodiment no difference in level is caused between the pixel area where whitening-out occurs and the surrounding area, so that the surrounding pixels can be smoothly connected with the pixel area where the whitening-out has occurred.

The present invention has been described based on the embodiments. These are merely exemplary, and other various modifications to the combination of each component and processing process thereof are possible. It is therefore understood by those skilled in the art that such modifications are also within the scope of the present invention.

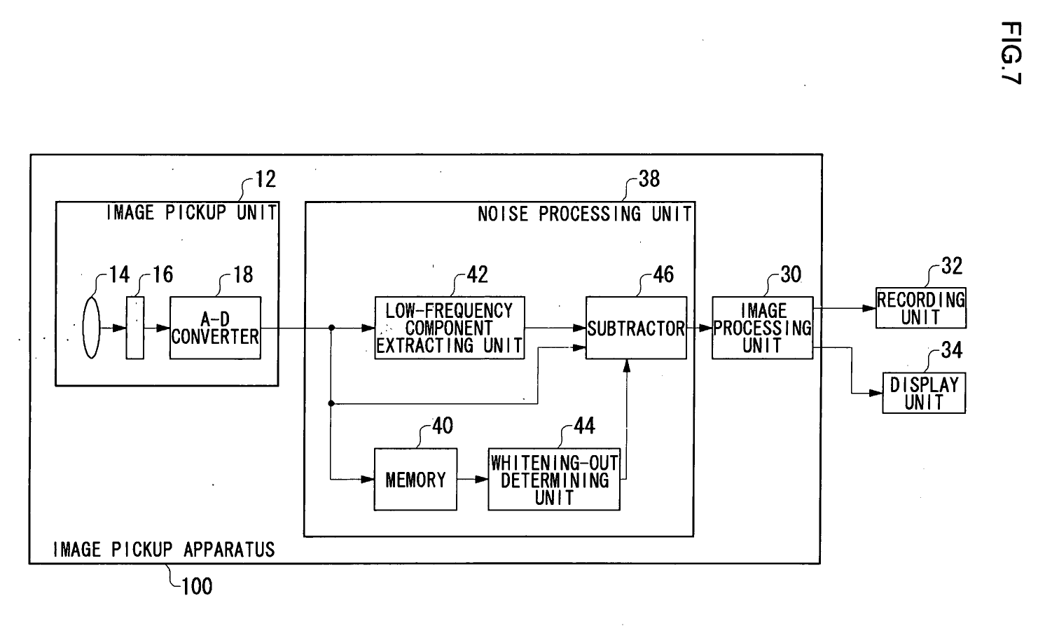

In the present embodiments described above, the noise processing is carried out in the order such that after data values of dark current noise are acquired, an image of an object is captured and the image data thereof are acquired. However, the noise processing may be carried out in the order such that after the image of an object is captured and the image data thereof are acquired, the data values of dark current noise are acquired. FIG. 7 illustrates a structure of a modification to the image pickup apparatus according to the present embodiment. An image pickup apparatus 100 shown in FIG. 7 differs in the structure of a noise processing unit 38 from the image pickup apparatus 10 shown in FIG. 1. The other components of the image pick up apparatus 100 are identical to those of the image pickup apparatus 10 shown in FIG. 1. A memory 40 has a function of storing the image data produced by an image pickup unit 12. A whitening-out determining unit 44 performs whitening-out determination on the image data stored in the memory 40. A low-frequency component extracting unit 42 extracts low-frequency components from the image data with the incident light to an image pickup device 16 being blocked, namely, the data values of dark current noise. For a pixel where it is determined by the whitening-out determining unit 44 that whitening-out is not caused, a subtractor 46 subtracts a data value of dark current noise from the data value of the pixel. For a pixel where it is determined by the whitening-out determining unit 44 that the whitening-out is caused, the low-frequency component of dark current noise extracted by the low-frequency extracting unit 42 is subtracted from the data value of the pixel.

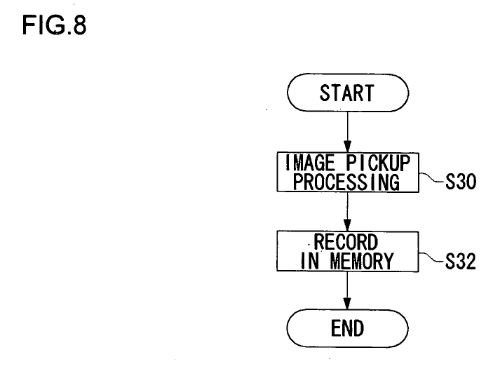

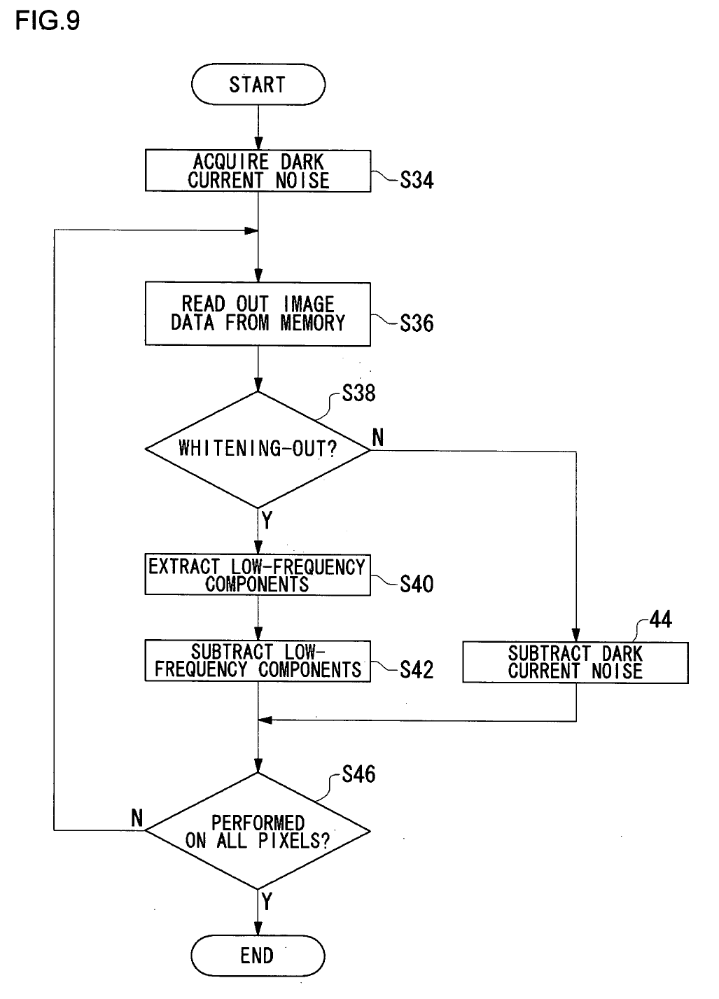

FIG. 8 and FIG. 9 are flowcharts according to modifications of the embodiment of the present invention. FIG. 8 is a flowchart for acquiring the image data according to a modification of the embodiment of the present invention. First, image data are acquired by the image pickup unit 12 (S30). The image data which have been converted into digital values by an A-D converter 18 are stored in the memory 40 (S32). This completes the acquisition processing of image data.

FIG. 9 is a flowchart of noise processing according to a modification of the embodiment of the present invention. After the processing of acquiring image data has been completed, the image data are acquired with the incident light to the image pickup device 16 being blocked, and data values of dark current noise are acquired (S34). The acquired data values of dark current noise may be stored in the low-frequency component extracting unit 42 and the subtractor 46. Also, an arrangement may be such that the acquired data values of dark current noise are temporarily held in the image pickup unit 12 and, thereafter, they are acquired sequentially from the image pickup unit 12 according to a subsequent processing. In such a case, it is no longer required that all of data values of dark current noise be stored in the noise processing unit 38, so that the memory usage can be reduced.

Next, the whitening-out determining unit 44 reads out the image data from the memory 40 (S36) and, performs whitening-out determination on each pixel, for instance (S38). If the whitening-out takes places in an image data pixel (Y of S38), the low-frequency component is extracted for the data values corresponding to said pixel (S40). Then, the low-frequency component of dark current noise is subtracted from the data values of said pixel (S42).

If, on the other hand, it is determined by the whitening-out determining unit 44 that the whitening-out does not take place in an image data pixel (N of S38), the data values of dark current noise are subtracted (S44). This processing is repeated until all pixels have undergone the subtraction processing (N of S46). When the subtraction processing has been performed on all pixels, the noise processing terminates (Y of S46).

It is preferred that the data values of dark current noise for image data be acquired in succession. Since the dark current noise is liable to be affected by the surrounding temperature environment, the dark current noise can be accurately removed by acquiring continuously the image data and the data values of dark current noise.

In the present embodiment described above, the processing of extracting low-frequency components of dark current noise is executed on pixels in which it is determined that the whitening-out has taken place. However, an arrangement may be such that the low-frequency components are beforehand extracted for all pixels at the stage when the dark current noise has been acquired. These low-frequency components may be recorded in memory or may be stored in a subtractor.

While the preferred embodiments of the present invention have been described using specific terms, such description is for illustrative purposes only, and it is to be understood that changes and variations may be made without departing from the spirit or scope of the appended claims.

What is claimed is:

1. A noise processing apparatus, comprising:
a decision unit which determines, for a pixel of image data generated by an image pickup unit, if a data value is greater than or equal to or strictly greater than a predetermined level; and
a subtractor which subtracts a low-frequency component of dark current noise of the image pickup unit from the data value of a pixel when it is determined by said decision unit, for the pixel, that the data value is greater than or equal to or strictly greater than the predetermined level.

2. A noise processing apparatus according to claim 1, further comprising a low-frequency component extracting unit which extracts a low-frequency component of dark current noise from the data value of dark current noise.

3. A noise processing apparatus according to claim 1, wherein when it is determined by said decision unit, for a pixel, that a data value of the pixel is strictly less than, or less than or equal to the predetermined level, said subtractor subtracts a data value of dark current noise for said pixel.

4. A noise processing apparatus according to claim 1, wherein the data value of dark current noise is acquired by blocking light incident to the image pickup unit.

5. A noise processing apparatus according to claim 4, wherein the data value of dark current noise is acquired before the image data are generated by the image pickup unit.

6. A noise processing apparatus according to claim 4, wherein the data value of dark current noise is acquired after the image data have been generated by the image pickup unit.

7. An image pickup apparatus, comprising:
an image pickup unit which picks up an image of an object and generates image data thereof;
a decision unit which determines, for a pixel of the image data generated by said image pickup unit, if a data value is greater than or equal to or strictly greater than a predetermined level;
a subtractor which subtracts a low-frequency component of dark current noise of said image pickup unit from the data value of a pixel when it is determined by said decision unit, for the pixel, that the data value is greater than or equal to or strictly greater than the predetermined level; and
an image processing unit which generates images, based on the data value of the pixel on which a subtraction processing is performed by said subtractor.

8. An image pickup apparatus according to claim 7, further comprising a low-frequency component extracting unit which extracts a low-frequency component of dark current noise from the data value of dark current noise.

9. An image pickup apparatus according to claim 7, wherein when it is determined by said decision unit, for a pixel, that a data value of the pixel is strictly less than, or less than or equal to the predetermined level, said subtractor subtracts a data value of dark current noise for said pixel.

10. An image pickup apparatus according to claim 7, wherein the data value of dark current noise is acquired by blocking light incident to said image pickup unit.

11. An image pickup apparatus according to claim 10, wherein the data value of dark current noise is acquired before the image data are generated by said image pickup unit.

12. An image pickup apparatus according to claim 10, wherein the data value of dark current noise is acquired after the image data have been generated by said image pickup unit.
